(19) United States
(12) Patent Application Publication
(10) Pub. No.: US 2026/0050647 A1
(43) Pub. Date: Feb. 19, 2026

(54) SYSTEM, METHOD AND COMPUTER-ACCESSIBLE MEDIUM FOR ACCELERATED GENERATION OF STATISTICALLY CORRELATED POINT STRUCTURES

(71) Applicant: New York University, New York, NY (US)

(72) Inventors: Aaron SHIH, New York, NY (US); Mathias CASIULIS, New York, NY (US); Stefano MARTINIANI, New York, NY (US)

(21) Appl. No.: 19/219,966

(22) Filed: May 27, 2025

Related U.S. Application Data
(60) Provisional application No. 63/651,613, filed on May 24, 2024.

(51) Int. Cl. G06F 17/15; G06F 17/14

(52) U.S. Cl. CPC G06F 17/156; G06F 17/142

(57) ABSTRACT

Exemplary systems, methods, and computer-accessible medium are provided that can optimize a design of an object. Thus, exemplary systems, methods, and computer-accessible medium can be provided that can apply a fast Fourier transform and/or non-uniform fast Fourier transform to generate continuous and discrete point structures with one or more arbitrary statistical correlations.

### CROSS REFERENCE TO RELATED APPLICATION(S)

This application relates to and claims the benefit of priority from U.S. Provisional Patent Application No. 63/651,613, filed on May 24, 2024, the entire disclosure of which is incorporated herein by reference.

### FIELD OF THE DISCLOSURE

The present disclosure relates to a generation of statistically correlated point structures, and more specifically to exemplary systems, methods and computer-accessible medium for generating continuous and discrete point structures with arbitrary statistical correlations (i.e., arbitrary spectral features and/or real space correlations) by applying a fast Fourier transform and/or non-uniform fast Fourier transform.

### BACKGROUND INFORMATION

The study of condensed matter systems is often greatly facilitated by the periodicity of the underlying atomic structures. For instance, the optical properties of crystals can be predicted using Bloch functions. (See, e.g., Ref. 1). The same cannot be said of disordered media (i.e., materials that do not exhibit conventional forms of long-range order), which cannot inherently take advantage of these simple mathematical structures, so that analytic models for disordered optical materials are still being developed. (See, e.g., Refs. 2-6). Among disordered materials, media with correlated disorder, whose structures amount to non-Poissonian random point patterns, have garnered a lot of attention due to experimental and computational reports of unconventional scattering properties such as structural coloration in lightweight structures (see, e.g., Refs. 7-8), isotropic transmission gaps (see, e.g., Refs. 10-12), and Anderson localization (see, e.g., Refs. 6, 13 and 14).

Beyond the realm of materials, it has been considered (see, e.g., Ref. 15) that what allows one to perceptually distinguish between textures are the n body correlations of the perceived point patterns. As a result, in computer graphics, protocols have been introduced to impose prescribed correlations in images. (See, e.g. Ref. 16). Among these, some have been designed to optimize the positions within a continuous point pattern rather than the intensities of pixels. (See, e.g., Ref. 17). In dithering, field visualization, or 3-D rendering (see, e.g., Refs. 18 and 19), such strategies can be seen as an optimal sampling problem: given some natural image, where should a finite number of sample points be placed in order to most faithfully retrieve the image and limit aliasing? The usual answer is that one should use blue-noise sampling (see, e.g., Ref. 20), i.e. point patterns with highly suppressed long-ranged pair correlations but no clear periodicity. In practice, this implies being able to optimize pair correlations in a point pattern, a problem for which many algorithms have been proposed (see, e.g., Refs. 18, 20-31), some of which can directly optimize the structure factor of the point pattern (see, e.g., Refs. 19, 20 and 25).

In physics, it is possible to call a blue-noise point pattern a superhomogeneous point pattern (see, e.g., Refs. 33-35) or, more commonly, disordered hyperuniform structure (see, e.g., Ref. 36). These systems exhibit abnormally suppressed long-range density fluctuations, leading to unconventional wave transport properties, e.g., complete isotropic photonic bandgaps (see, e.g., Refs. 10-12) and Anderson localization (see, e.g., Refs. 6, 37 and 38). Naturally, algorithms have also been developed in this context to produce hyperuniformity by optimizing the spectral properties of point patterns (see, e.g., Refs. 39-44), a strategy dating back to reverse Monte Carlo (see, e.g., Ref. 45). These algorithms suffer from a major drawback, namely their algorithmic complexity, which is [symbol] (N²) (see, e.g., Ref. 44), or even [symbol] (N³) (see, e.g., Refs. 39-43) in the number, N, of points. In practice, such poor scaling means that the vast majority of hyperuniform point patterns used to study the emergent physical properties of this class of materials contained 10² to 10⁴ points (see, e.g., Refs. 39-41, 43, 46 and 47), or were limited to one specific kind of hyperuniformity to make the calculations tractable (see, e.g., Refs. 6, 44 and 48), often at a significant computational cost while only affording access to modest system sizes (for example, up to ˜10⁶ points using a massively parallel GPU implementation) (see, e.g., Ref. 44). This is particularly problematic in 3-D cases (see, e.g., Refs. 38 and 47), where the linear size of the system reaches only tens of particles across. Such limitations have critically affected the scale of hyperuniform materials characterized in experiments, typically a few hundreds of particles only (see, e.g., Refs. 10 and 11). This raises the question of whether the structures used in past studies, often only a few tens of particles across, truly encoded hyperuniformity, an inherently long-range property.

Thus, it may be beneficial to provide exemplary systems, methods and computer-accessible mediums, which can overcome at least the deficiency described herein above.

### SUMMARY OF EXEMPLARY EMBODIMENTS

Exemplary systems, methods, and non-transitory computer accessible medium according to certain exemplary embodiments of the present disclosure can be provided which can optimize the design of an object by applying a fast Fourier transform and/or non-uniform fast Fourier transform to generate point structures with one or more arbitrary statistical correlations. In some exemplary embodiments of the present disclosure, the optimization can occur in a continuous space without discretizing Fourier space.

Furthermore, in some exemplary embodiments of the present disclosure, the optimizing of a design can comprise optimizing a position or characteristic of a plurality of elements. In some exemplary embodiments of the present disclosure, the characteristic of the plurality of elements can comprises a size, a density, and/or a refractive index.

Exemplary systems, methods, and non-transitory computer accessible medium according to certain exemplary embodiments of the present disclosure can be provided which can optimize the design of at least one object by applying a fast Fourier transform and/or non-uniform fast Fourier transform to optimize at least one of at least one position or at least one characteristic of a plurality of elements of the object. Furthermore, exemplary systems, methods, and non-transitory computer accessible medium according to certain exemplary embodiments of the present disclosure can be provided which can optimize the design of an object by using a fast Fourier transform to optimize loss of gradient in a linear time scale.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1(a) is an exemplary visualization of a Fast Reciprocal-Space Correlator procedure according to an exemplary embodiment of the present disclosure;

FIGS. 1(b)-1(e) are exemplary outputs of the Fast Reciprocal-Space Correlator procedure according to an exemplary embodiment of the present disclosure;

FIG. 2(a) is a diagram of an exemplary method for Ewald sphere construction and single scattering according to an exemplary embodiment of the present disclosure;

FIG. 2(b) is an exemplary illustration of the Ewald circle construction on a 2-Dtriangular lattice according to an exemplary embodiment of the present disclosure;

FIG. 2(c) is an exemplary illustration of an optimized 2-D point pattern (N=5×107) with a spiral of zeros in its S(q) according to an exemplary embodiment of the present disclosure;

FIG. 2(d) is an exemplary illustration of a typical structure factor according to an exemplary embodiment of the present disclosure;

FIGS. 2(e) and 2(f) are exemplary illustrations of exemplary transmission plots, T(k, θ). Superimposed onto S(q) according to an exemplary embodiment of the present disclosure;

FIGS. 3(a)-3(d) are exemplary graphs showing exemplary number fluctuations against measurement window size for hyperuniform structures according to an exemplary embodiment of the present disclosure;

FIG. 4(a) is an exemplary illustration of the Fast Reciprocal-Space Correlator procedure in the presence of both real and reciprocal space losses according to an exemplary embodiment of the present disclosure;

FIGS. 4(b) and 4(c) are exemplary graphs showing structure factors of hyperuniform monodisperse according to an exemplary embodiment of the present disclosure;

FIG. 4(d) is an exemplary visualization of a forward-scattered transmission for equilibrium hard spheres at φ=0.25 up to kmax=200 according to an exemplary embodiment of the present disclosure;

FIG. 4(c) is an exemplary graph showing a relative change of forward-scattered transmission between exemplary 3-D power-law hyperuniform structures illustrated in FIG. 4(b) and the starting equilibrium hard sphere configuration according to an exemplary embodiment of the present disclosure;

FIG. 5 is an exemplary graph and an illustration of exemplary tailored point patterns for MC integration according to an exemplary embodiment of the present disclosure;

FIG. 6(a) is an exemplary flow diagram for an exemplary inverse design of optical metamaterials according to an exemplary embodiment of the present disclosure;

FIG. 6(b) is an illustration of an exemplary original point pattern generated by a Fast Reciprocal-Space Correlator procedure and its transmission spectrum according to an exemplary embodiment of the present disclosure; and

FIG. 7 is an illustration of an exemplary block diagram of an exemplary system in accordance with certain exemplary embodiments of the present disclosure;

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

The following description of exemplary embodiments provides non-limiting representative examples referencing numerals to particularly describe features and teachings of different aspects of the present disclosure. The exemplary embodiments described should be recognized as capable of implementation separately, or in combination, with other exemplary embodiments from the description of the exemplary embodiments. A person of ordinary skill in the art reviewing the description of the exemplary embodiments should be able to learn and understand the different described aspects of the present disclosure. The description of the exemplary embodiments should facilitate understanding of the exemplary embodiments of the present disclosure to such an extent that other implementations, not specifically covered but within the knowledge of a person of skill in the art having read the description of embodiments, would be understood to be consistent with an application of the exemplary embodiments of the present disclosure.

The exemplary systems, methods and computer-accessible medium according to the exemplary embodiments of the present disclosure can be provided that introduce an optimal formulation of this inverse problem by means of the fast Fourier transform and/or non-uniform fast Fourier transform, thus arriving at an exemplary procedure configured to generate exemplary systems with arbitrary statistical correlations, with a computational cost that scales [symbol] (N log N) with system size. The exemplary method is extended to accommodate arbitrary real-space interactions, such as short-range repulsion, to simultaneously control short- and long-range correlations. As an example, the exemplary systems, methods and computer-accessible medium according to the exemplary embodiments of the present disclosure can generate the largest-ever stealthy hyperuniform configurations in 2-D (N=10⁹) and 3-D (N>10⁷). With an Ewald sphere construction, the exemplary systems, methods and computer-accessible medium according to the exemplary embodiments of the present disclosure can then elucidate the link between spectral and optical properties at the single-scattering level, and show that large, yet finite, stealthy hyperuniform structures in 2-D and 3-D generically display bandgap-like features in their transmission, thus providing a concrete example of how this method enables fine tuning of a physical property at will. However, the exemplary systems, methods and computer-accessible medium according to the exemplary embodiments of the present disclosure can also show that large 3-D power-law hyperuniformity in particle packings leads to single-scattering properties near-identical to those of simple hard spheres. An exemplary approach according to the exemplary systems, methods and computer-accessible medium according to the exemplary embodiments of the present disclosure for the fast optimization of the spectral properties of point patterns can extend readily beyond materials design, for instance to blue-noise sampling and texture generation in computer graphics.

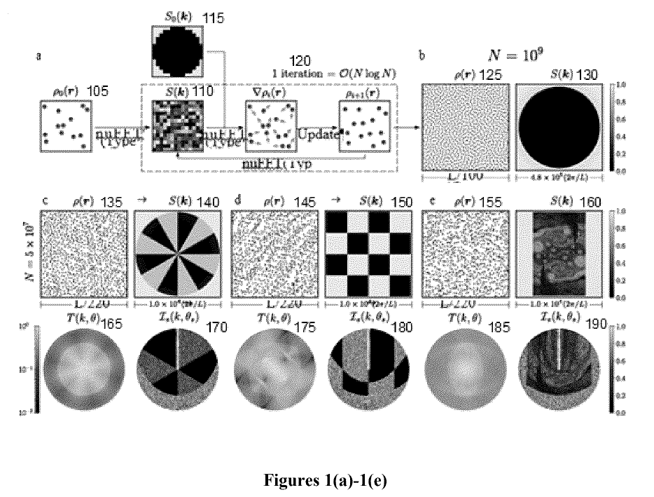

The exemplary systems, methods and computer-accessible medium according to the exemplary embodiments of the present disclosure introduce a powerful optimization procedure, as illustrated in FIG. 1(a), that can generate spectrally-shaped disordered point structures with arbitrary spectral features (see FIGS. 1(b)-1(e)). For example, as shown in FIG. 1(a), a point pattern ρ₀(r) 105 can be subjected to a nuFFT transformation, so that a loss can be computed from the difference between the observed k-space structure, S(k) 110, and a target function, S₀(k) 115. The gradient of this loss can be obtained as another nuFFT, so that each iteration 120 of the optimization can be performed in O(N log N) operations. FIG. 1(b) shows an exemplary output of the system/procedure of FIG. 1(a). Specifically, FIG. 1(b) shows a small portion of an N=10⁹ point pattern 125, as well as the final structure factor 130. FIGS. 1(c)-1(e) show additional exemplary outputs imposing a variety of arbitrary target structures to smaller systems (N=5×10⁷ points). For example, FIG. 1(c) shows a pinwheel with point pattern 135, final structure factor 140, forward scattering transmission 165, T(k, θ), as a function of the magnitude, k, and orientation, of an incoming wave, and scattered intensity 170, Iₛ(k, θ) for an upward incident wave-vector, as a function of the incident frequency, k, and of the scattered direction, θₛ. FIG. 1(d) shows a checkerboard of alternated ones and zeros with point pattern 145, final structure factor 150, forward scattering transmission 175, T(k, 8), as a function of the magnitude, k, and orientation, of an incoming wave, and scattered intensity 180, Iₛ(k, θ) for an upward incident wave-vector, as a function of the incident frequency, k, and of the scattered direction, θₛ. FIG. 1(e) shows the lightness scale of Van Gogh's Starry Night with point pattern 155, final structure factor 160, forward scattering transmission 185, T(k, θ), as a function of the magnitude, k, and orientation, of an incoming wave, and scattered intensity 190, Iₛ(k, θ) for an upward incident wave-vector, as a function of the incident frequency, k, and of the scattered direction, θₛ.

In short, the exemplary procedure of the exemplary systems, methods and computer-accessible medium of the present disclosure can resort to fast Fourier transform (FFT) and/or non-uniform Fast Fourier Transforms (nuFFTs) to efficiently compute or otherwise determine the structure factor S(k) of a point pattern ρ(r). The distance from S(k) to a prescribed target S₀(k) can then define a loss, the gradient of which can also be written as a nuFFT, so that the cost of one step in a minimization procedure can scale quasilinearly in the system size, i.e., i.e., O(N log N). The exemplary systems, methods and computer-accessible medium according to the exemplary embodiments of the present disclosure can jointly optimize this cost function with additional physical constraints, such as short-ranged pair repulsion, with no increase of computational complexity. The exemplary systems, methods and computer-accessible medium according to the exemplary embodiments of the present disclosure demonstrate application of the exemplary procedure for systems containing as many as 10⁹ points (see FIG. 1(b)), outclassing all previously published methods possessing the same specificity in k-space for point patterns (see, e.g., Refs. 39, 40 and 44), or even for discrete ones (see, e.g., Ref. 42). The target structure factor, S₀, can be chosen at will as long as the number of k-space features being directly constrained does not exceed the number of degrees of freedom: a few smaller (N=5×10⁷) examples are shown in FIGS. 1(c)-1(e), where a pinwheel in FIG. 1(c), a checkerboard in FIG. 1(d), or Van Gogh's Starry Night (see, e.g., Ref. 32) in FIG. 1(e) are embedded into the structure factor.

The exemplary systems, methods and computer-accessible medium according to the exemplary embodiments of the present disclosure can also show (see bottom row of FIGS. 1(c)-(e)) that the optical properties of such structures can be readily characterized in the single-scattering regime on the scale of realistic devices, without assuming periodicity: the exemplary systems, methods and computer-accessible medium according to the exemplary embodiments of the present disclosure show the forward-scattered transmission pattern, T, of these structures against the wave-vector of an incoming plane wave, as well as the intensity, Iₛ, of the scattered field in each direction, for a vertical incident wave, across frequencies (see precise definitions below). The exemplary systems, methods and computer-accessible medium according to the exemplary embodiments of the present disclosure highlights the range of applications of such a powerful procedure for photonics applications.

The exemplary systems, methods and computer-accessible medium according to the exemplary embodiments of the present disclosure can reveal that unquestionably stealthy hyperuniform systems have bandgap-like features at the single-scattering level. However, the exemplary systems, methods and computer-accessible medium according to the exemplary embodiments of the present disclosure can also reveal that systems with excluded volume and power-law behavior in S, such as those reported in systems of jammed particles (see, e.g., Refs. 50-53) and absorbing-state models (see, e.g., Refs. 54-58), have single scattering properties largely indistinguishable from those of equilibrium hard spheres, which is reminiscent of similar results for the density of states of small 2-D stealthy hyperuniform systems and equilibrium hard disks (see, e.g., Ref. 46).

### Exemplary Procedure

Fast Reciprocal-Space Correlator (FReSCo) can be a minimization protocol against a loss L defined as the least square error between the structure factor S(k) for a point configuration (r₁, . . . , r_{N}), and a prescribed target structure factor S₀(k) in a finite region K of reciprocal space:

$${L}_{s} [ {r}_{1} , … , {r}_{N} ] = {\sum }_{k ∈ K} ω ( k ) L [ S ( k ) , {S}_{0} ( k ) ] , \qquad ( 1 )$$

where w(k) is a weighting function, and {

$$L [ S ( k ) , {S}_{0} ( k ) ] = \{ \begin{matrix}{[ ( S ( k ) - {S}_{0} ( k ) ) / {S}_{0} ( k ) ]}^{2} & if {S}_{0} ( k ) \neq 0 \\ {S ( k )}^{2} & otherwise\end{matrix}$$

penalizes the relative distance to the target. In practice, the exemplary systems, methods and computer-accessible medium according to the exemplary embodiments of the present disclosure can choose w(k)˜|k|^{|-(d-1)} when S₀(k) has pronounced radial symmetry around (k)=0, so as to impose the (k)-space constraints equally strongly on every spherical shell. For instance, this applies to the structure factors of FIGS. 1(b) and 1(c), while for panels in FIGS. 1(d) and 1(e), the exemplary systems, methods and computer-accessible medium according to the exemplary embodiments of the present disclosure can choose w(k)=1.

The structure factor S(k) is the expression of the pair correlation function g2(r) in k-space. For a given set of N points with weights En in continuous space, the density field is a sum of N delta functions at their respective coordinates, ρ(r)=Σn≤N Cn δr−rₙ), with normalized weights ^{C}n=N. In Fourier space, \hat{p}(k)=Σn ^{C}n exp(ik rₙ) so that

$$S ( k ) ≡ \frac{{\vert \hat{p} ( k ) \vert}^{2}}{N} \qquad ( 2 )$$

Note that since ρ(r) is real-valued, S(k)=S(−k), a property of the Fourier transform known in crystallography as Friedel's law (see, e.g., Refs. 59 and 60), so that only centrosymmetric are realizable. For instance, this property is why embedding Starry Night (see, e.g., Ref. 32) in the k_{y}<0 half-plane leads to its inversion being constrained for k_{y}>0 shown in FIG. 1(e). Using Eq. 2, the gradients of the loss function can be written as a Fourier transform (see Exemplary Methods),

$$\frac{\partial {ℒ}_{S}}{\partial {r}_{n}} = Re ⌈ {\sum }_{k} C ( k ) {c}_{n} exp ( - ik \cdot {r}_{n} ) ⌉ = {c}_{n} Re [ \hat{C} ( {r}_{n} ) ] \qquad ( 3 )$$

where C(k)=−4 ikw(k) [S(k)−S₀(k)] \hat{p}(k)/N are coefficients of a Fourier series, and @ is the Fourier transform of C. In the following, without any loss of generality, the exemplary systems, methods and computer-accessible medium according to the exemplary embodiments of the present disclosure can use ^{C}n=1.

The size of the domain in which the optimization can be performed, N_{K}=|k|, counted in number of discrete wave-vectors, is limited in practice by the number of degrees of freedom, dN, for a pattern of N points embedded in a d-dimensional space. This constraint often leads to defining a ratio χ≡N_{K}/(2dN) (see, e.g., Refs. 6, 39, 40 and 44), where the two stems from Friedel's law. Optimizations with χ<1 are in theory possible, while those with χ≥1 are overconstrained and cannot necessarily be achieved. In practice, past work has reported good achievability with other exemplary procedures using χ≤0.5. (see, e.g., Ref. 39). The exemplary systems, methods and computer-accessible medium according to the exemplary embodiments of the present disclosure set χ≈0.4, so that the number of k-space features constrained scales linearly with N.

The bulk of the computations consists of Fourier transforms between uniform and nonuniform spaces (see FIG. 1(a)). The exemplary systems, methods and computer-accessible medium according to the exemplary embodiments of the present disclosure can use the Flatiron Institute Nonuniform Fast Fourier Transform (FINUFFT) framework which provides transforms of three types and is highly optimized for multithreaded CPU computations (see, e.g., Refs. 61 and 62). Type-1 refers to a nonuniform to uniform transform (e.g. real space points to a k-space grid as used in the calculation of the structure factor in Eq. 2). Type-2 refers to a uniform to nonuniform transform (e.g. k-space grid to known points in real space as used in the calculation of the loss gradient in Eq. 3). Type-3 refers to a nonuniform to nonuniform transform (e.g. real space points to specific points in k-space, as used in the calculation of the Ewald sphere, see below).

In total, one Type-1 evaluation can used for the calculation of S(k) and d additional Type-2 evaluations are required for the gradient of S(k), where d is the dimensionality of the system. As these are the most costly steps in calculating the loss, the efficiency of the exemplary procedure of the exemplary systems, methods and computer-accessible medium according to the exemplary embodiments of the present disclosure is [symbol] (N log N) for loss and gradient calls (see benchmark in SI), which can be orders of magnitude faster than the [symbol] (N²) or [symbol] (N³) of previous algorithms (see, e.g., Refs. 39, 40 and 44). Coupled with the state-of-the-art optimizations built into FINUFFT, the computational speed increase of the exemplary systems, methods and computer-accessible medium according to the exemplary embodiments of the present disclosure can be enormous, enabling generation of correlated disordered systems up to N=10⁹ on CPUs (see FIG. 1(b)), with the main limitation being the memory requirements. The optimization itself can be performed in the exemplary systems, methods and computer-accessible medium according to the exemplary embodiments of the present disclosure by feeding the configuration and gradient—to L-BFGS (see, e.g., Ref. 63), a common quasi-Newton method, with a maximal step size and a backtracking line-search (see, e.g., Ref. 64).

### Exemplary Structure and Scattering

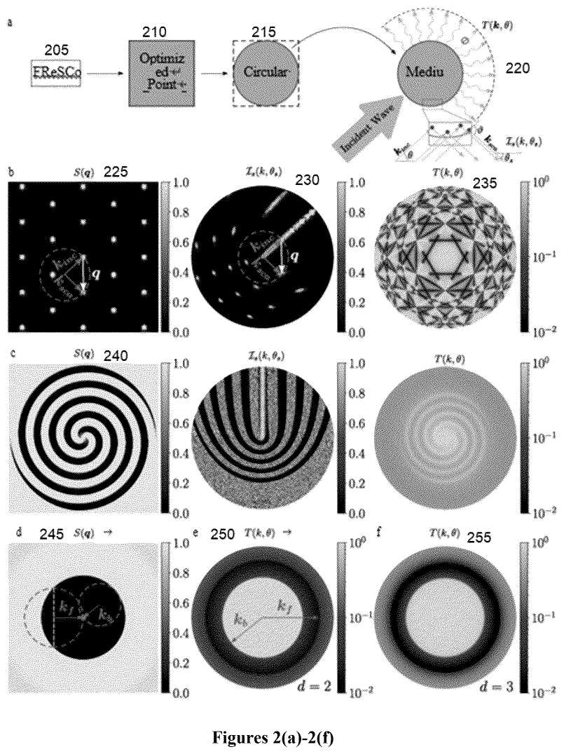

The structure factor can fully determine single-scattering properties of a set of small objects in the far-field through the Ewald sphere construction (see, e.g., Refs. 1, 65, 66). In order to characterize the optical behavior of the systems generated by FReSCo, at scale, without introducing artificial periodicity, the exemplary systems, methods and computer-accessible medium according to the exemplary embodiments of the present disclosure can proceed as follows: first, the optimized point patterns can be cut into disks to avoid artificial anisotropy coming from the shape of the medium (as done in experiments (see, e.g., Ref. 11)); then, the Ewald construction can be used on the resulting object by means of FINUFFT Type-3 transformations. FIG. 2(a) shows one such exemplary process. Specifically, a central disk 215 is cut from an optimized structure 210 generated by FReSCo 205. The single-scattering properties of central disk 215 can be measured at 220. To an incoming wavevector, k_{inc}, the far-field, normalized scattered intensity, Iₛ is associated, in direction θₛ.

The exemplary systems, methods and computer-accessible medium according to the exemplary embodiments of the present disclosure can outline the derivation of the Ewald sphere construction in the SI, the exemplary technique is illustrated in FIG. 2(b). FIG. 2(b) shows Ewald circle construction on a 2-D triangular lattice. From the structure factor 225 S(q) evaluated at q=k_{sca}−k_{inc}, one gets Iₛ 230 which, once integrated, yields T as a function of the incident wave-vector 235. Structure factor 225 S(q) at q=k_{sca}−k_{inc}, the difference between the scattered wavevector k_{sca} and the incident wavevector k_{inc}, is proportional to the far-field scattered intensity in the single-scattering approximation (see, e.g., Ref. 67).

Therefore, at any given frequency k=|k_{inc}|=|k_{sca}|, the exemplary systems, methods and computer-accessible medium according to the exemplary embodiments of the present disclosure can draw or otherwise generate a sphere centered at −k_{inc} with radius k. The values of the structure factor, S(q), on the surface of this Ewald sphere represent the scattered intensities in each of the k_{sca} directions for a given k_{inc}. In FIG. 2(b), the exemplary systems, methods and computer-accessible medium according to the exemplary embodiments of the present disclosure can further illustrate this procedure by showing the scattered intensity profile, Iₛ 230, normalized by the total scattered intensity at each k, for a single incident illumination direction, but varying the wave-vector magnitude k (radial direction), and the observation direction θₛ (orthoradial direction).

In order to account for a finite detection width, the exemplary systems, methods and computer-accessible medium according to the exemplary embodiments of the present disclosure can also define the 2-D transmission, T(k_{inc}), as the scattered intensity in the forward half-circle, F, around the incident direction, θ, normalized by the total scattered intensity on the full circle, C, removing from both integrals the direction ϑ=0 that reduces to the peak S(0)=N, i.e.,

$$T ( {k}_{inc} ) = \frac{{\int }_{ℱ \backslash 0} S [ k \hat{e} ( θ + ϑ ) - k \hat{e} ( θ ) ] d ϑ}{{∮}_{𝒞 \backslash 0} S [ k \hat{e} ( θ + ϑ ) - k \hat{e} ( θ ) ] d ϑ} , \qquad ( 4 )$$

where ϑ is the angle between the incident and scattered waves. The 3-D definition is a straightforward generalization with the circle replaced by a sphere, the angle by a solid angle, and the forward half-circle by a forward half-sphere. The exemplary systems, methods and computer-accessible medium according to the exemplary embodiments of the present disclosure can demonstrate in SI that this strategy can lead to the same output as solving the full optical problem in the single-scattering regime.

FIG. 2(c) illustrates the various possibilities opened up by FreSCo: for example, a spiral-shaped domain of zeros in the structure factor 240, for N=5×10⁷ particles, leads to fringes of low scattered intensities in a range of frequencies, and to a spiral-shaped transmission pattern. This example, together with the examples shown FIG. 1(c)-1 (e), can demonstrate that achieving fine control over S(q) in large point patterns facilitates the design of intricate scattering behaviors. Further, the exemplary systems, methods and computer-accessible medium according to the exemplary embodiments of the present disclosure can take advantage of this approach to study stealthy hyperuniform structures, systems with S(k)=0 in a disk of radius K, at scale: FIG. 2(d) illustrates a typical structure factor 245 and, FIGS. 2(e) and 2(f) illustrate exemplary transmission plots, T(k, θ). Specifically, FIG. 2(e) shows transmission plot, T(k, θ) 250 for a generated stealthy hyperuniform structure for N=5×10⁷ in 2-D, and FIG. 2(f) shows transmission plot, T(k, θ) 255 for a generated stealthy hyperuniform structure for N=5×10⁶ in 3-D.

Superimposed onto S(q), the exemplary systems, methods and computer-accessible medium according to the exemplary embodiments of the present disclosure can highlight the two special values of k expected to have particular significance in the Ewald construction.

The first such value, k_{b}=K/2, separates the domain k<k_{b} in which the system is transparent (up to multiple scattering effects [47, 68]) from the domain k>k_{b} in which the system backscatters, as the back of the Ewald circle hits high values of S(k). The second special value, k_{ƒ}=K/√2, separates the regimes k<k_{ƒ} where only backscattering happens, and k>k_{ƒ}, where forward-scattering sets in, down to narrower and narrower angles as the frequency increases. Therefore, a trough of lower forward-scattered transmission can be expected to be at intermediate k, suggestive of an isotropic bandgap, in a stealthy hyperuniform configuration. This picture is confirmed in the transmission plot of panel (e), obtained for a 2-D configuration with N=5×10⁷ points, where these values are reported, and in panel (ƒ), obtained for a 3-D configuration with N=5×10⁶ points. Note that the reason for using a smaller system in 3d is a limitation of FINUFFT type 3: in order to evaluate nonuniform points from nonuniform points, the algorithm utilizes a uniform fine grid intermediate. The amount of required memory increases rapidly with the largest magnitude of k in the calculation due to the generation of this fine grid. As a result, large 3d systems can be prohibitively memory intensive to analyze in this fashion.

While similar observations were made for 2-D systems (see, e.g., Refs. 6, 10-12, 37, 44 and 46), the result of the exemplary systems, methods and computer-accessible medium according to the exemplary embodiments of the present disclosure constitutes the largest direct check that stealthy hyperuniform systems do feature isotropic bandgap-like features in 2-D, and the first such measurement of a stealthy hyperuniform systems in 3-D, as well as the largest for 3-D hyperuniform systems of any kind (see, e.g., Refs. 38, 70 and 71). Note that the Ewald construction also indicates that a smaller angular integration domain in the definition of T (i.e., a smaller detector) leads to a broader transmission trough, so that by integrating over the full half-disk or half-sphere the exemplary systems, methods and computer-accessible medium according to the exemplary embodiments of the present disclosure can provide the narrowest observable transmission gap, see SI.

### Exemplary Disordered Hyperuniform Structures

From a k-space perspective, hyper-uniformity is associated with an anomalous decay of the structure factor, S(k), at long range, or S(k)−+0 when |k|−+0. How the structure factor decays depends on the class of hyperuniform system (see, e.g., Ref. 72). The exemplary systems, methods and computer-accessible medium according to the exemplary embodiments of the present disclosure can be applied to two general types of disordered hyperuniformity: stealthy and power-law. Stealthy hyperuniformity occurs when S(k)=0 for |k|<K, like the examples of FIGS. 1(b) and 2(d), while power-law hyperuniform systems exhibit S(k)˜|k|^{α} for |k|<K for some α>0. One issue with many of the heretofore small realizations of hyper-uniform structures considered in the literature is that it is not obvious that the limited extent of the prescribed k-space features is sufficient to achieve the suppression of density fluctuations on large length scales. In other words, the structure factor of the optimized point pattern may appear consistent with power-law hyperuniformity (see, e.g., Refs. 40, 70, 73 and 74), but the system is not actually hyperuniform (e.g., this happens for a 3-D system with N=103 particles, see SI). Concretely, hyperuniformity can be quantified in real space by counting the number of points that fall within spheres of radius [symbol] centered at random points within the sample. A point pattern is said to be hyperuniform if the variance in the number of points sampled across spheres, grows slower than their volume, viz., [symbol] N² [symbol] / [symbol] N² [symbol] −1˜ [symbol] , with d≤β≤d+1, while in an uncorrelated point pattern [symbol] N² [symbol] / [symbol] N² [symbol] −1˜ [symbol] . The exemplary systems, methods and computer-accessible medium according to the exemplary embodiments of the present disclosure can utilize FReSCo to generate structures for which these power laws are verified over several decades of [symbol] .

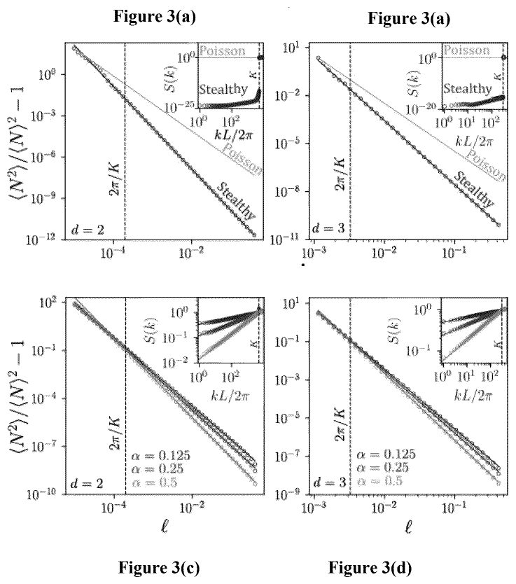

First, the exemplary systems, methods and computer-accessible medium according to the exemplary embodiments of the present disclosure can demonstrate the possibilities opened up by the [symbol] (N log N) scaling of the exemplary method by generating stealthy hyperuniform systems of up N=10⁹ points (see FIG. 1(b)) and FIGS. 3(a) and 3(b) illustrate the final radially averaged structure factors (insets) and the associated number fluctuations, shown here as the reduced variance, [symbol] N² [symbol] / [symbol] N² [symbol] −1, against the radius of a measurement sphere (main panels) for N=5×10⁷ in 2-D and 3-D respectively, where stealthy [symbol] and Poisson [symbol] scalings are shown as solid lines, as well as a Poisson structure factor S(k)=1 in the inset. These exemplary configurations can constitute the largest ever examples of disordered stealthy hyperuniform point patterns, and are orders of magnitude larger than any previous realization (see, e.g., Refs. 6, 12, 38-40, 42-44, 46 and 68), as well as the most solid evidence of stealthy hyperuniformity in a system being associated with a [symbol] N² [symbol] / [symbol] N² [symbol] −1˜ [symbol] decay of number fluctuations.

Inspired by critical configurations of absorbing-phase models (see, e.g., Refs. 54-58) and jammed packings (see, e.g., Refs. 50-53), the exemplary systems, methods and computer-accessible medium according to the exemplary embodiments of the present disclosure can also provide power-law hyperuniform point patterns by constraining the structure factor S(k)˜|k|^{α} such that the structure factor at the largest wavevector magnitude being constrained is S (K)=1. The exemplary systems, methods and computer-accessible medium according to the exemplary embodiments of the present disclosure can minimize 10 configurations of N=5×10⁷ point systems for power laws α∈{0.125, 0.25, 0.5}. FIGS. 3(c) and 3(d) illustrate the final structure factors (insets) and the associated number fluctuations against £ (main panels) in 2-D and 3-D, respectively. The decay in the variance matches the predicted trends, [symbol] N² [symbol] / [symbol] N² [symbol] −1 [symbol] (see, e.g., Ref. 72), decades beyond the length scale 2π/K. The exemplary systems, methods and computer-accessible medium according to the exemplary embodiments of the present disclosure constitute by far the largest, and most rigorous, test of the real-space properties of power-law hyperuniform point patterns reported to date.

### Exemplary Hyperuniform Particle Packings

The exemplary systems, methods and computer-accessible medium according to the exemplary embodiments of the present disclosure only constrained Fourier-space properties of point patterns. Thus, e.g., there was no notion of excluded volume around points, and it was highly likely that two points would come arbitrarily close together for some choices of target structure factor (n.b., this is not the case for stealthy hyperuniform systems, in which points tend to be well spaced from one another). This fact precludes the fabrication of certain raw point patterns (e.g., power-law hyperuniform) without the use of arbitrary geometric transformations (see, e.g., Ref. 10). In order to generate more physical systems, the exemplary systems, methods and computer-accessible medium according to the exemplary embodiments of the present disclosure can introduce a hybrid loss that combines the structure factor loss, Eq. 1, with a repulsive pair potential Uᵣₑₚ,

$$ℒ = ℒ s + \sum {U}_{rep} ( {r}_{m} - {r}_{n} ) . \qquad ( 5 )$$

$$m < n$$

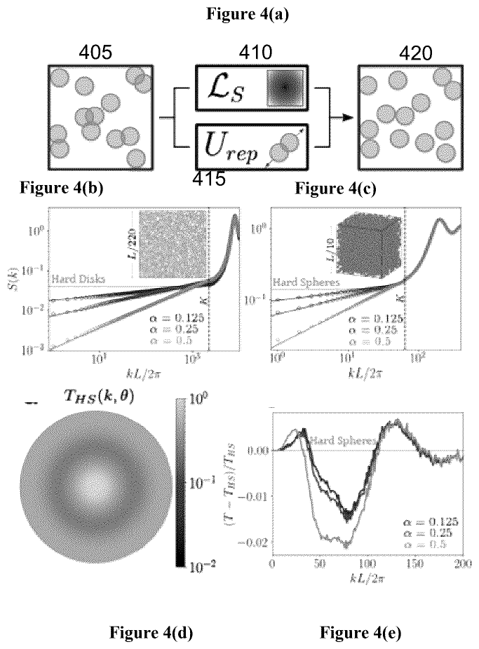

The exemplary procedure for this variant of FRESCo according to the exemplary embodiment of the present disclosure is shown in FIG. 4(a) where from a uniform distribution of initial positions 405 (for the 2-D case) or an equilibrium hard sphere configuration (for the 3-D case), exemplary embodiments can jointly optimize for prescribed features in k-space and short-range repulsion 420. This includes introduction of real structure factor loss 410 and repulsive pair potential Uᵣₑₚ 415. Notice that any short-ranged potential ensures that computing the loss or its gradient is still [symbol] (N log N) in time. It is possible to introduce polydispersity into the exemplary system by specifying individual particle diameters in U_{rep.} in which case, to get the correct definition of S for homogeneous polydisperse spheres, one needs to weigh each particle by the ratio of its d-dimensional volume Vₙ to the mean volume [symbol] V [symbol] , i.e, cₙ=Vₙ/ [symbol] V [symbol] in Eq. 3 (see, e.g., Refs. 75, 76). The exemplary systems, methods and computer-accessible medium according to the exemplary embodiments of the present disclosure can select a monodisperse Hertzian potential, Uᵣₑₚ(r)∝(r−σ)^{2.5}, with σ being the repulsive diameter. In order for the low-k constraint and the high-k structure resulting from short-range repulsion to match, the exemplary systems, methods and computer-accessible medium according to the exemplary embodiments of the present disclosure can adjust the prefactor in front of the power-law at small |k|, as well as the extent, K, of the domain in which the structure factor is constrained, such that S₀(K) smoothly interpolates the Percus-Yevick approximation for the structure factor of hard sphere liquids in 3-D (see, e.g., Refs. 77-79), and a similar approximation in 2 (see, e.g., Ref. 80), which can be evaluated using the Jscatter library (see, e.g., Ref. 81). The exemplary results using the exemplary systems, methods and computer-accessible medium according to the exemplary embodiments of the present disclosure thus obtained are shown in FIGS. 4(b) and 4(c). For example, FIG. 4(b) shows structure factors of hyperuniform monodisperse in disk packings (2-D), and FIG. 4(c) shows structure factors of hyperuniform monodisperse in sphere packings (3-D). The insets for these figures depict packings of the hyperuniform α=0.5 power law system. Structure factors are averaged over 10 realizations of systems of N=5×10⁷ particles with K=5050 for 2-D and N=4×10⁶ particles with K=64 for 3-D. Volume fractions are φ=0.6 for 2-D and φ=0.25 for 3D. The exemplary results for the exemplary systems, methods and computer-accessible medium according to the exemplary embodiments of the present disclosure show that arbitrary long-range features can still be achieved in the presence of excluded volume, which in turn controls short range features, guaranteeing the fabricability of the obtained structures with actual physical objects.

Using the Ewald construction, the exemplary systems, methods and computer-accessible medium according to the exemplary embodiments of the present disclosure can be provided to generate the single-scattering transmissions of these 3-D configurations. FIG. 4(d) illustrates the resulting forward-scattered transmission, Tus, for an equilibrium hard sphere configuration (obtained using event-chain Monte Carlo methods (see, e.g., Ref. 82) at ϕ=0.25 up to kₘₐₓ=200, and in FIG. 4(e) the relative change between Tus and the transmission, T, of power-law hyperuniform structures (same as in FIG. 4(c)), radially averaged over incoming angles. The exemplary systems, methods and computer-accessible medium according to the exemplary embodiments of the present disclosure can reveal that power-law hyperuniformity, even in such large systems, does not significantly affect the scattering properties of hard sphere systems in the single-scattering limit, as the largest relative change is only a few percents. This result, while reminiscent of past work comparing equilibrium hard disks to stealthy hyperuniform structures (see, e.g., Ref. 46), is the first direct measurement in large power-law hyperuniform systems. In particular, it shows that hyperuniformity per se, as realized in critical systems like jammed packings, is not directly linked to the observation of a transmission gap in the single scattering regime, so that past works suggesting the existence of a transmission gap (see, e.g., Refs. 70 and 71) must have relied on multiple scattering effects, and/or higher order correlations.

Beyond the examples in this section, using a similar hybrid loss, it is possible for the exemplary systems, methods and computer-accessible medium according to the exemplary embodiments of the present disclosure to impose not just short range repulsion, but also more complicated real-space interactions—for instance a set of constraints onto the real-space pair correlation function (see Exemplary Methods herein), or potentials that favor local orientational order (such as, e.g., 3-body terms, e.g. Stillinger-Weber-type potentials (see, e.g., Ref. 83). Doing so can shed light on the role of short-range and higher-body interactions in the system's wave-transport properties. It can be advantageous for fabrication where tetrahedral order, which is also observed in real-life structures [9], is often imposed a posteriori (see, e.g., Refs. 10, 70, 71 and 84). Furthermore, the exemplary procedure of the exemplary systems, methods and computer-accessible medium according to the exemplary embodiments of the present disclosure can be adopted to advance the fundamental understanding of power-law hyperuniformity in particle packings, as it seems to be associated with criticality at jamming (see, e.g., Refs. 51-53 and 85), and ideality in glasses (see, e.g., Refs. 73 and 86).

### EXEMPLARY CONCLUSIONS

The exemplary systems, methods and computer-accessible medium according to the exemplary embodiments of the present disclosure can be provided that demonstrate a highly efficient generative procedure, FReSCo, that precisely embeds k-space features into point patterns up to previously inaccessible scales. Adding short-range repulsion to the optimization, the exemplary systems, methods and computer-accessible medium according to the exemplary embodiments of the present disclosure can ensure short-range excluded volume around particle while prescribing specific correlations at long-range. With system sizes as large as N=10⁹ particles, this exemplary method can pave the way to a better understanding of the link between long-range correlations in disordered materials and their transport properties. FReSCo can be a valuable tool to understand non-trivial properties of naturally occurring disordered systems that exhibit rich optical behavior, like the structural color of animals and plants (see, e.g., Refs. 7-9, 87-93).

Eventually, FReSCo can contribute to the study and design of exemplary wave transport properties such as new structural colored coatings (see, e.g., Ref. 94), photonic glasses (see, e.g., Refs. 95 and 96), random lasers (see, e.g., Refs. 97-99), or Anderson localization (see, e.g., Refs. 5, 6, 13, 14, 68 and 100-103). The exemplary systems, methods and computer-accessible medium according to the exemplary embodiments of the present disclosure may be able to focus on establishing the full multiple-scattering response of point patterns at large scales, either numerically using recently developed methods (see, e.g., Refs. 5, 6 and 48), or analytically using effective-medium theory (see, e.g., Refs. 47 and 67). Taking advantage of modern 3-D printing technologies (see, e.g., Refs. 43, 104 and 105), one could even bring FReSCo outputs into the experimental realm.

Going one step beyond, it is possible to optimize not the structure factor, but the full optical response of a point pattern either at the single-scattering level, using stealthy hyperuniform domains as drawing boards within the Ewald sphere construction (see, e.g., Ref. 106), or at the full multiple-scattering level.

The procedure of the exemplary systems, methods and computer-accessible medium according to the exemplary embodiments of the present disclosure can also be generalized to include higher-order correlations, for instance 3- and 4-body correlations, that are also computable in [symbol] (N log N) using FFTs (see, e.g., Ref. 107). Such an extension can allow to probe how many-body correlations affect transport properties in point patterns, a question that is intimately tied to the multiple-scattering regime.

Finally, in the context of computer graphics, the exemplary systems, methods and computer-accessible medium according to the exemplary embodiments of the present disclosure can provide a means to improve blue-noise sampling methods, or to generate non-trivial textures

### Exemplary Methods

Analytical gradients—Exemplary writing of the gradient of the structure factor loss, LS, analytically as a Fourier series. From Eq. 1 of the main text, the reciprocal-space loss reads

$${ℒ}_{S} [ {r}_{1} , … , {r}_{N} ] = {\sum }_{k ∈ K} ω ( k ) L [ S ( k ) , {S}_{0} ( k ) ] \qquad ( 6 )$$

where w(k) is a weighting function, and

$$L [ S ( k ) , {S}_{0} ( k ) ] = \{ \begin{matrix}{{[ ( S ( k ) - {S}_{0} ( k ) ) / {S}_{0} ( k ) ]}^{2}}^{I} & if {S}_{0} ( k ) \neq 0 \\ {S ( k )}^{2} & otherwise\end{matrix} .$$

For simplicity, in this section, the exemplary systems, methods and computer-accessible medium according to the exemplary embodiments of the present disclosure can absorb the normalization by S₀ into the weighting function ω(k)=ω(k)/S₀(k)² if S₀(k)≠0 and W(k)=ω(k) otherwise, so that at every point can be written

$${ℒ}_{S} [ {r}_{1} , … , {r}_{N} ] = {\sum }_{\vert k \vert < K} W ( k ) {( S ( k ) - {S}_{0} ( k ) )}^{2} . \qquad ( 7 )$$

Since only the structure factor S is a function of the structure of the point pattern, the derivative of this last expression with respect to one component a of the position of particle n reads

$$\frac{\partial ℒ s}{\partial {r}_{n , a}} = {\sum }_{\vert k \vert < K} 2 W ( k ) ( S ( k ) - {S}_{0} ( k ) ) \frac{\partial S ( k )}{\partial {r}_{n , a}} . \qquad ( 8 )$$

Recalling that the structure factor can be written as

$$S ( k ) = \frac{\vert \hat{p} ( k ) {\vert}^{2}}{N} = \frac{1}{N} \hat{p} ( k ) {\hat{p}}^{†} ( k ) , \qquad ( 9 )$$

and that the derivative of the Fourier transform of the density field reads

$$\frac{\partial \hat{ρ} ( k )}{\partial {r}_{n}} = {ikc}_{n} {e}^{ik \cdot {r}_{n}} , \qquad ( 10 )$$

the gradient components of S can be recast as

$$\frac{\partial S}{\partial {r}_{n}} = \frac{{ikc}_{n}}{N} ( {\hat{ρ}}^{†} ( k ) {e}^{ik \cdot {r}_{n}} - \hat{ρ} ( k ) {e}^{- ik \cdot {r}_{n}} ) . \qquad ( 11 )$$

This expression may be simplified by noticing that it is the sum of a number with its conjugate, so that

$$\frac{\partial S}{\partial {r}_{n}} = 2 {c}_{n} Re [ - \frac{ik}{N} \hat{p} ( k ) {e}^{- ik \cdot {r}_{n}} ] . \qquad ( 12 )$$

Injecting this expression into Eq. 8, one recovers Eq. 3 of the main text.

Pair correlation function optimization—The optimization strategy of the exemplary systems, methods and computer-accessible medium according to the exemplary embodiments of the present disclosure can be generalized to also jointly optimize a real-space pair correlation function g(r), which can be defined as a Fourier transform of S−1,

$$g ( r ) = \frac{1}{{ρ}_{0}} {\int }_{- ∞}^{∞} dk ( S ( k ) - 1 ) {e}^{- ik \cdot r} , \qquad ( 13 )$$

where ρ₀ is the average number density. The associated loss term can be written as a sum over a discrete set R of constrained distances x

$${ℒ}_{g} ≡ {\sum }_{x ∈ ℛ} U ( x ) {( g ( x ) - {g}_{0} ( x ) )}^{2} , \qquad ( 14 )$$

where U is a weight function that can for instance select short-range order to be jointly optimized with some longer-range property in S. The gradient of this loss term with respect to the position rₙ of particle can be expressed as

$$\frac{\partial {ℒ}_{g}}{\partial {r}_{n}} = {\sum }_{x ∈ ℛ} 2 U ( x ) ( g ( x ) - {g}_{0} ( x ) ) \frac{\partial g}{\partial {r}_{n}} ( x ) . \qquad ( 15 )$$

Since structures are optimized in finite periodic boxes, the integral in the definition 13 actually reduces to a discrete Fourier transform,

$$g ( r ) = Re [ \frac{{V}_{k}}{{ρ}_{0}} {\sum }_{k} ( S ( k ) - 1 ) {e}^{- ik \cdot r} ] , \qquad ( 16 )$$

where Vk=(2/L)^{d} is the discretization volume used when switching to a discrete Fourier transform. As a result, one may express the gradient of g with respect to the position rₙ of particle ⁿ as

$$\frac{\partial g}{\partial {r}_{n}} ( x ) = Re [ \frac{{V}_{k}}{{ρ}_{0}} {\sum }_{k} \frac{\partial S ( k )}{\partial {r}_{n}} {e}^{- ik \cdot x} ] . \qquad ( 17 )$$

The gradient of [symbol] _{g} can then be expressed as

$$\frac{\partial {ℒ}_{g}}{\partial {r}_{n}} = \frac{2 {V}_{k}}{{ρ}_{0}} Re [ {\sum }_{k} \frac{\partial S ( k )}{\partial {r}_{n}} {\sum }_{x ∈ ℛ} U ( x ) ( g ( x ) - {g}_{0} ( x ) ) {e}^{- ik \cdot x} ] . \qquad ( 18 )$$

Finally, one may define

$$G ( k ) ≡ 2 {\sum }_{r ∈ ℛ} U ( x ) ( g ( x ) - {g}_{0} ( x ) ) {e}^{- ik \cdot x} \qquad ( 19 )$$

such that

$$\frac{\partial {ℒ}_{g}}{\partial {r}_{n}} = \frac{{V}_{k}}{{ρ}_{0}} Re [ {\sum }_{k} \frac{\partial S ( k )}{\partial {r}_{n}} G ( k ) ] . \qquad ( 20 )$$

All in all, introducing the weight cₙ of each point again,

$$\frac{\partial {ℒ}_{g}}{\partial {r}_{n}} = \frac{{V}_{k} {c}_{n}}{{ρ}_{0} N} Re [ {\sum }_{k} ik {ρ}^{†} ( k ) G ( k ) {e}^{ik \cdot {r}_{n}} ] - \frac{{V}_{k} {c}_{n}}{{ρ}_{0} N} {}_{I} Re [ {\sum }_{k} ik ρ ( k ) G ( k ) {e}^{- ik \cdot {r}_{n}} ] . \qquad ( 21 )$$

This last expression is now written as two Fourier transforms. As Equations 16 and 21 can be evaluated using regular FFTs, the loss minimization in g(r) may thus be performed in [symbol] (N log N) time as well (per iteration).

Exemplary Optimal Monte Carlo Rendering with Spectrally-Shaped Point Patterns

Exemplary computer rendering of surfaces in a 3-D environment is a computationally expensive task for animated movies and video games. As computer graphics become more and more realistic, finer and finer calculations of surface details are required. Efficient methods of computation are especially important for video games due to the necessity to render large, 3-D scenes in real time. One of the core problems to solve in rendering is the estimation and integration of a landscape or surface by sampling at a finite number of points.

Basic sampling theory (see, e.g., Ref. 108) indicates that a signal containing a finite interval of frequencies can be perfectly reconstructed, and its integral perfectly computed (see, e.g., Ref. 109), using points regularly spaced on a grid at a fine enough resolution. However, using this strategy is almost never optimal in practice, either because a fine enough grid would require an enormous amount of sample points, or because the function to be integrated contains frequencies going all the way to infinity: in rendered scenes, any object with sharp boundaries has an unbounded frequency content. As a result, it is in practice advantageous to use random sets of non-uniformly spaced points, so that the integration can be performed using a Monte Carlo estimator (see, e.g., Ref. 109). When doing so, the mean-square error on the integral, which sets the number of points required to render a scene at an acceptable noise level, can be written (see, e.g., Ref. 110) in terms of frequency contents of the point pattern and of the integrand ƒ, namely MSE_{N}[SN, ƒ]∝Σk (SN(k))Pƒ(k)/N, where k is a d-dimensional frequency, (SN(k)) is the power spectrum of the point pattern averaged over realizations, and Pf (k) is the power spectrum of the function ƒ. For instance, using a Poisson point process, S_{N}=1, leads to MSE_{N}˜O(1/N), while correlated point patterns like blue-noise sampling (see, e.g., Ref. 111) may display faster decay for generic functions (see, e.g., Ref. 110).

An important consequence of this expression can be that, for any given function ƒ and finite N, there exists an optimal set of point patterns with an S^{opt}N [ƒ]=argmin[MSE_{N}] that minimizes the error. Intuitively, this optimal structure has to be near-zero at frequencies where the function ƒ has high power, so that the set of points does not suffer from strong strobing effects. It is typically costly to finely optimize the structure factor of a point pattern, as it naïvely requires O(N³) operations (see, e.g., Refs. 112 and 113). However, the exemplary systems, methods and computer-accessible medium according to the exemplary embodiments of the present disclosure can provide (see, e.g., Ref. 114) an optimization scheme, which relies on non-uniform Fast Fourier transforms (see, e.g., Refs. 115 and 116), that produces such point patterns at only O(N log N) costs, on par with times required to generate standard correlated point systems used in MC integration (see, e.g., Refs. 110, 110 and 118-131).

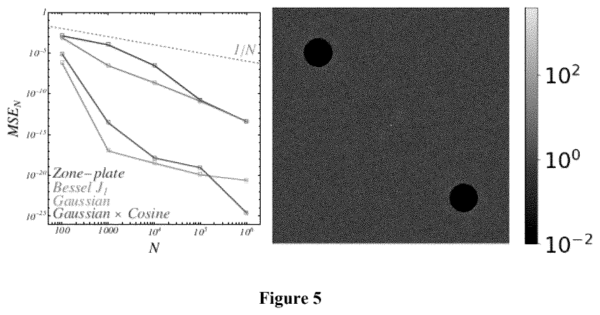

The exemplary systems, methods and computer-accessible medium according to the exemplary embodiments of the present disclosure can thus provide an exemplary procedure that can systematically tailor point patterns to specific integrands at virtually no extra cost compared to current strategies. This is illustrated in FIG. 5, where the use of a tailored point pattern reduces the finite-N MSE by several orders of magnitude. The left graph of FIG. 5 shows log-log scaling of the MSE against N compared to a naïve MC integral (dashed line) for a few example 2-D functions, namely a zone-plate commonly used in antialiasing assessment (see, e.g., Ref. 2), a Bessel function, a Gaussian, and the product of a Gaussian by a cosine. The illustration on the right of FIG. 5 shows a tailored power spectrum for Gaussianx cosine.

While most strategies used in existing algorithms focus on creating correlated point patterns that lower integration error for functions with mostly low-frequency content (blue noise (see, e.g., Refs. 110 and 111), or hyperuniform point patterns (see, e.g., Ref. 132)), the exemplary procedure of the exemplary systems, methods and computer-accessible medium according to the exemplary embodiments of the present disclosure can tackle arbitrary functions, possibly with high power spectra only at high frequencies (see right-most panel shown FIG. 5). In practice, such gain can achieve a given target MSE at a much smaller N than with other strategies. As a smaller N can mean a lighter computational load per frame rendered, using the exemplary procedure according to the exemplary embodiments of the present disclosure instead of conventional ones constitutes a systematic improvement, snowballing to massive time and energy gains at the scale of a whole video game or movie.

Given the interest displayed by the graphics community for much more limited strategies of point pattern optimization (see, e.g., Ref. 133), the exemplary systems, methods and computer-accessible medium according to the exemplary embodiments of the present disclosure can have a significant impact throughout the animation industry.

### Exemplary On-Demand Inverse Design of Optimal Optical Metamaterials

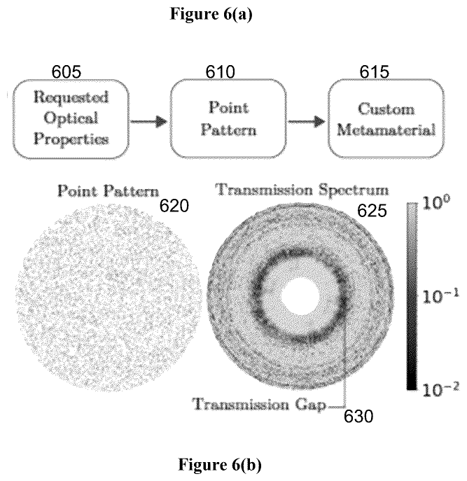

The exemplary systems, methods and computer-accessible medium according to the exemplary embodiments of the present disclosure can provide a platform for creating amorphous metamaterials with custom optical properties. The exemplary systems, methods and computer-accessible medium according to the exemplary embodiments of the present disclosure are relevant in industries researching and manufacturing optoelectronic and biomedical devices. Such devices often consist of several optical components, such as waveguides and bandpass filters, requiring materials with highly specified optical properties. With the framework provided by the exemplary systems, methods and computer-accessible medium according to the exemplary embodiments of the present disclosure, custom-tailored optical metamaterials can be generated and architected to exhibit requested optical properties. FIG. 6(a) shows this proposed framework where a client requests a material with specific optical properties at 605. Exemplary embodiments of the present disclosure can be used to generate a point pattern 610 from the requested parameters. Using the point pattern as a blueprint, a custom metamaterial exhibiting desired optical properties and be fabricated at 615.

Development of modern optical devices mainly utilizes photonic crystals (see, e.g., Refs. 133-135), which are highly ordered structures. As a consequence, photonic crystals are highly anisotropic, exhibiting strong optical properties in only certain directions. Furthermore, photonic crystal properties are highly sensitive to manufacturing defects breaking order.

Rather than be limited to crystalline materials, the exemplary systems, methods and computer-accessible medium according to the exemplary embodiments of the present disclosure can leverage disorder. By introducing statistical correlations into an otherwise disordered structure, the exemplary systems, methods and computer-accessible medium according to the exemplary embodiments of the present disclosure can create coherent wave scattering phenomena (see, e.g., Refs. 136 and 137). Due to their disordered nature, materials according to the exemplary systems, methods and computer-accessible medium according to the exemplary embodiments of the present disclosure are far more robust to manufacturing defects than photonic crystals. The exemplary systems, methods and computer-accessible medium according to the exemplary embodiments of the present disclosure can even design isotropic optical materials, exhibiting the same properties in any direction. However, the exemplary systems, methods and computer-accessible medium according to the exemplary embodiments of the present disclosure can also design any anisotropy into the material if desired, as they are not limited by crystal structure. An example of a device that would benefit from our service is the solar cell. One issue with the efficiency of solar cells is that they absorb a wider range of light wavelengths than optimal, leading to unnecessary heating of the solar cell over time, and accelerating degradation of optical components within. The exemplary systems, methods and computer-accessible medium according to the exemplary embodiments of the present disclosure can design an isotropic reflectance coating that only permits near-optimal wavelengths of light into the solar cell, while scattering the rest. As the rejected light is scattered and not absorbed, heating is kept to a minimum, prolonging the life and efficiency of the solar cell. Because the reflectance is isotropic, misalignment with respect to the sun will not affect the performance of the coating.

The exemplary systems, methods and computer-accessible medium according to the exemplary embodiments of the present disclosure can provide a fast, efficient numerical protocol capable of designing two-point correlations into large point patterns and calculating the transmission properties of their corresponding optical metamaterials (see, e.g., Ref. 138).

FIG. 6(b) illustrates an original point pattern 620 that exhibits a wide, isotropic transmission gap 630 in the transmission spectrum 625. Incident light with wavelengths within this range cannot penetrate into the material and are instead back-scattered, regardless of orientation. In order to link structural correlations with real optical properties, the exemplary systems, methods and computer-accessible medium according to the exemplary embodiments of the present disclosure can employ automatic differentiation on the transmission calculation to determine relevant correlations. The exemplary systems, methods and computer-accessible medium according to the exemplary embodiments of the present disclosure can then fully understand the design space and thus design optical properties directly into metamaterials.

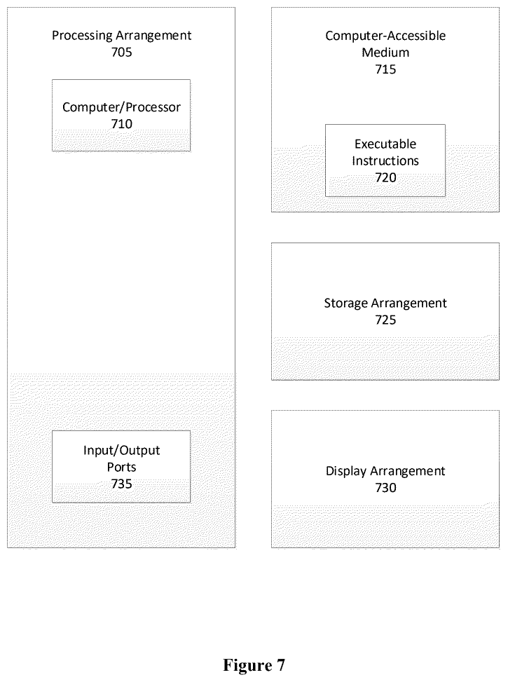

FIG. 7 shows a block diagram of an exemplary embodiment of a system according to the present disclosure, which can be utilized either in part or completely with any one or more of the exemplary embodiments of the present disclosure as provided in the enclosed Appendix. For example, exemplary procedures in accordance with the present disclosure described herein can be performed by a processing arrangement and/or a computing arrangement 702. Such processing/computing arrangement 702 can be, for example entirely or a part of, or include, but not limited to, a computer/processor 704 that can include, for example one or more microprocessors, and use instructions stored on a computer-accessible medium (e.g., RAM, ROM, hard drive, or other storage device).

As shown in FIG. 7, for example a computer-accessible medium 706 (e.g., as described herein above, a storage device such as a hard disk, floppy disk, memory stick, CD-ROM, RAM, ROM, etc., or a collection thereof) can be provided (e.g., in communication with the processing arrangement 702). The computer-accessible medium 706 can contain executable instructions 708 thereon. In addition, or alternatively, a storage arrangement 710 can be provided separately from the computer-accessible medium 706, which can provide the instructions to the processing arrangement 702 so as to configure the processing arrangement to execute certain exemplary procedures, processes and methods, as described herein above, for example.

Further, the exemplary processing arrangement 702 can be provided with or include an input/output arrangement 714, which can include, for example a wired network, a wireless network, the internet, an intranet, a data collection probe, a sensor, etc. FIG. 7 shows that the exemplary processing arrangement 702 can be in communication with an exemplary display arrangement 712, which, according to certain exemplary embodiments of the present disclosure, can be a touch-screen configured for inputting information to the processing arrangement in addition to outputting information from the processing arrangement, for example. Further, the exemplary display 712 and/or a storage arrangement 710 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and paragraphs thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference, in their entireties:
1. C. Kittel, Introduction to Solid-state Physics (John Wiley & Sons, New York, 1953).
2. S. Yu, C. W. Qiu, Y. Chong, S. Torquato, and N. Park, Nature Reviews Materials 6, 226 (2021).
3. K. Vynck, R. Pierrat, R. Carminati, L. S. Froufe-Pérez, F. Scheffold, R. Sapienza, S. Vignolini, and J. J. Sáenz, Arxiv Preprint, 2106.13892 (2021).
4. S. E. Skipetrov, European Physical Journal B 93, 70 (2020).
5. S. E. Skipetrov, Physical Review B 102, 1 (2020).
6. R. Monsarrat, R. Pierrat, A. Tourin, and A. Goetschy, Physical Review Research 4, 033246 (2022).
7. M. Burresi, L. Cortese, L. Pattelli, M. Kolle, P. Vukusic, D. S. Wiersma, U. Steiner, and S. Vignolini, Scientific Reports 4, 1 (2014).
8. B. D. Wilts, X. Sheng, M. Holler, A. Diaz, M. Guizar-Sicairos, J. Raabe, R. Hoppe, S. H. Liu, R. Langford, O. D. Onelli, D. Chen, S. Torquato, U. Steiner, C. G. Schroer, S. Vignolini, and A. Sepe, Advanced Materials 30, 201702057 (2018).
9. K. Djeghdi, U. Steiner, and B. D. Wilts, Advanced Science 9, 2202145 (2022).
10. M. Florescu, S. Torquato, and P. J. Steinhardt, Proceedings of the National Academy of Sciences of the United States of America 106, 20658 (2009).
11. W. Man, M. Florescu, K. Matsuyama, P. Yadak, G. Na-hal, S. Hashemizad, E. Williamson, P. Steinhardt, S. Torquato, and P. Chaikin, Optics Express 21, 19972 (2013).
12. M. A. Klatt, P. J. Steinhardt, and S. Torquato, Proceedings of the National Academy of Sciences of the United States of America 119, e2213633119 (2022).
13. L. S. Froufe-Pérez, M. Engel, J. J. Saenz, and F. Schef-fold, Proceedings of the National Academy of Sciences of the United States of America 114, 9570 (2017).
14. A. Dikopoltsev, S. Weidemann, M. Kremer, A. Stein-furth, H. H. Sheinfux, A. Szameit, and M. Segev, Science Advances 8, eabn7769 (2022).
15. B. Julesz, IRE Transactions on Information Theory 8, 84 (1962).
16. J. Dong, J. Liu, K. Yao, M. Chantler, L. Qi, H. Yu, and M. Jian, Sensors (Switzerland) 20, 1135 (2020).
17. P. Tu, D. Lischinski, and H. Huang, Computer Graphics Forum 38, 109 (2019).
18. H. Li, L. Y. Wei, P. V. Sander, and C. W. Fu, ACM Transactions on Graphics 29, 167 (2010).
19. L. Y. Wei, ACM SIGGRAPH 2010 Papers, SIGGRAPH 2010 1, 79 (2010).
20. R. A. Ulichney, Proceedings of the IEEE, 56 (1988).
21. D. P. Mitchell, Proceedings of the 14th Annual Conference on Computer Graphics and Interactive Techniques, SIGGRAPH 1987 21, 65 (1987).
22. D. P. Mitchell, Proceedings of the 18th Annual Conference on Computer Graphics and Interactive Techniques, SIGGRAPH 1991 25, 157 (1991).
23. Y. Eldar, M. Lindenbaum, M. Porat, and Y. Y. Zeevi, in Proceedings of the 12th IAPR International Conference on Pattern Recognition, Vol. 2—Conference B: Computer Vision & Image Processing (IEEE, Jerusalem, Israel, 1994) pp. 93-97.
24. S. Hiller, O. Deussen, and A. Keller, in Workshop on Visio, Modeling, and Visualization (VMV), November 2001 (Stuttgart, 2001).
25. W.-m. Pang, Y. Qu, T.-t. Wong, D. Cohen-or, and P.-a. Heng, in SIGGRAPH '08, Vol. 89 (2001) pp. 1-8.
26. V. Ostromoukhov, C. Donohue, and P. M. Jodoin, in ACM SIGGRAPH 2004 Papers, SIGGRAPH 2004 (2004) pp. 488-495.
27. A. C. Öztireli and M. Grossy, ACM Transactions on Graphics 31, 170 (2012).
28. J. Chen, X. Ge, L. Y. Wei, B. Wang, Y. Wang, H. Wang, Y. Fei, K. L. Qian, J. H. Yong, and W. Wang, ACM Transactions on Graphics 32 (2013).
29. D. Heck, T. Schlomer, and O. Deussen, ACM Transactions on Graphics 32, 1 (2013).
30. M. S. Ebeida, M. A. Awad, X. Ge, A. H. Mahmoud, S. A. Mitchell, P. M. Knupp, and L. Y. Wei, CAD Computer Aided Design 46, 25 (2014).
31. D. M. Yan, J. W. Guo, B. Wang, X. P. Zhang, and P. Wonka, Journal of Computer Science and Technology 30, 439 (2015).
32. V. van Gogh, “Starry Night,” (1889).
33. A. Gabrielli, B. Jancovici, M. Joyce, J. L. Lebowitz, L. Pietronero, and F. Sylos Labini, Physical Review D-Particles, Fields, Gravitation and Cosmology 67, 043506 (2003).
34. A. Gabrielli, M. Joyce, and S. Torquato, Physical Review E-Statistical, Nonlinear, and Soft Matter Physics 77, 031125 (2008).
35. S. Ghosh and J. Lebowitz, Journal of Statistical Physics 166, 1016 (2017).
36. S. Torquato, Physics Reports 745, 1 (2018).
37. L. S. Froufe-Pérez, M. Engel, J. J. Sáenz, and F. Scheffold, Proceedings of the National Academy of Sciences of the United States of America 114, 9570 (2017).
38. J. Haberko, L. S. Froufe-Pérez, and F. Scheffold, Nature Communications 11, 4867 (2020).
39. O. U. Uche, F. H. Stillinger, and S. Torquato, Physical Review E-Statistical Physics, Plasmas, Fluids, and Related Interdisciplinary Topics 70, 046122 (2004).
40. O. U. Uche, S. Torquato, and F. H. Stillinger, Physical Review E-Statistical, Nonlinear, and Soft Matter Physics 74, 031104 (2006).
41. S. Torquato, Soft Matter 5, 1157 (2009).
42. D. Chen and S. Torquato, Acta Materialia 142, 152 (2018).
43. S. Gorsky, W. A. Britton, Y. Chen, J. Montaner, A. Lenef, M. Raukas, and L. Dal Negro, APL Photonics 4, 110801 (2019).
44. P. K. Morse, J. Kim, P. J. Steinhardt, and S. Torquato, Arxiv Preprint, 2304.09139 (2023).
45. R. L. McGreevy, Journal of Physics Condensed Matter 13, R877 (2001).
46. L. S. Froufe-Pérez, M. Engel, P. F. Damasceno, N. Muller, J. Haberko, S. C. Glotzer, and F. Scheffold, Physical Review Letters 117, 1 (2016).
47. S. Torquato and J. Kim, Physical Review X 11, 21002 (2021).
48. O. Leseur, R. Pierrat, and R. Carminati, Optica 3, 763 (2016).
49. A. F. Oskooi, D. Roundy, M. Ibanescu, P. Bermel, J. D. Joannopoulos, and S. G. Johnson, Computer Physics Communications 181, 687 (2010).
50. Y. Jiao and S. Torquato, Physical Review E-Statistical, Nonlinear, and Soft Matter Physics 84, 041309 (2011).
51. C. E. Zachary, Y. Jiao, and S. Torquato, Physical Review E 83, 051308 (2011).
52. S. Atkinson, G. Zhang, A. B. Hopkins, and S. Torquato, Physical Review E 94, 012902 (2016).
53. M. A. Klatt and S. Torquato, Physical Review E 94, 022152 (2016).
54. L. Corté, P. M. Chaikin, J. P. Gollub, and D. J. Pine, Nature Physics 4, 420 (2008).
55. D. Hexner and D. Levine, Physical Review Letters 114, 110602 (2015).
56. D. Hexner, P. M. Chaikin, and D. Levine, Proceedings of the National Academy of Sciences of the United States of America 114, 4294 (2017).
57. D. Hexner, A. J. Liu, and S. R. Nagel, Physical Review Letters 121, 115501 (2018).
58. S. Wilken, R. E. Guerra, D. Levine, and P. M. Chaikin, Physical Review Letters 127, 38002 (2021).
59. G. Friedel, Bulletin de la Société française de Minéralogie 36, 211 (1913).
60. D. Schwarzenbach, Crystallography (John Wiley & Sons, 1996).
61. A. H. Barnett, J. Magland, and L. Af Klinteberg, SIAM Journal on Scientific Computing 48, C479 (2019).
62. A. H. Barnett, Applied and Computational Harmonic Analysis 51, 1 (2021).
63. D. C. Liu and J. Nocedal, Mathematical Programming 45, 503 (1989).
64. J. Nocedal and S. Wright, Numerical Optimization (Springer, 1999).
65. P. P. Ewald, Annalen der Physik 369, 253 (1921).
66. Y. L. Loh, American Journal of Physics 85, 277 (2017).
67. R. Carminati and J. C. Schotland, Principles of Scattering and Transport of Light (Cambridge University Press, 2021).
68. O. Leseur, R. Pierrat, J. J. Sáenz, and R. Carminati, Physical Review A—Atomic, Molecular, and Optical Physics 90, 053827 (2014).
69. [ ]
70. S. F. Liew, J. K. Yang, H. Noh, C. F. Schreck, E. R. Dufresne, C. S. O'Hern, and H. Cao, Physical Review A-Atomic, Molecular, and Optical Physics 84, 063818 (2011).
71. N. Muller, J. Haberko, C. Marichy, and F. Scheffold, Advanced Optical Materials 2, 115 (2014).
72. C. E. Zachary and S. Torquato, Journal of Statistical Mechanics: Theory and Experiment 2009, P12015 (2009).
73. G. Zhang, F. H. Stillinger, and S. Torquato, Scientific Reports 6, srep36963 (2016).
74. G. Zhang and S. Torquato, Physical Review E 101, 32124 (2020).
75. A. Vrij, The Journal of Chemical Physics 69, 1742 (1978).
76. D. Frenkel, R. J. Vos, C. G. De Kruif, and A. Vrij, The Journal of Chemical Physics 84, 4625 (1986).
77. J. K. Percus and G. J. Yevick, Physical Review 110, 1 (1958).
78. M. S. Wertheim, Physical Review Letters 10, 321 (1963).
79. J.-P. Hansen and I. R. McDonald, Theory of simple liquids (Elsevier Academic Press, 2006).
80. Y. Rosenfeld, Physical Review A 42, 5978 (1990).
81. R. Biehl, PLOS ONE 14, 0218789 (2019).
82. E. P. Bernard, W. Krauth, and D. B. Wilson, Physical Review E-Statistical, Nonlinear, and Soft Matter Physics 80, 5 (2009).
83. F. H. Stillinger and T. A. Weber, Physical Review B 31, 5262 (1985).
84. M. A. Klatt, P. J. Steinhardt, and S. Torquato, Proceedings of the National Academy of Sciences of the United States of America 116, 23480 (2019).
85. P. Rissone, E. I. Corwin, and G. Parisi, Physical Review Letters 127, 38001 (2020).
86. T. Yanagishima, J. Russo, R. P. Dullens, and H. Tanaka, Physical Review Letters 127, 215501 (2021).
87. E. R. Dufresne, H. Noh, V. Saranathan, S. G. Mochrie, H. Cao, and R. O. Prum, Soft Matter 5, 1792 (2009).
88. H. Noh, S. F. Liew, V. Saranathan, R. O. Prum, S. G. Mochrie, E. R. Dufresne, and H. Cao, Physical Review E-Statistical, Nonlinear, and Soft Matter Physics 81, 051923 (2010).
89. S. Vignolini, M. P. Davey, R. M. Bateman, P. J. Rudall, E. Moyroud, J. Tratt, S. Malmgren, U. Steiner, and B. J. Glover, New Phytologist 196, 1038 (2012).
90. S. Vignolini, P. J. Rudall, A. V. Rowland, A. Reed, E. Moyroud, R. B. Faden, J. J. Baumberg, B. J. Glover, and U. Steiner, Proceedings of the National Academy of Sciences of the United States of America 109, 15712 (2012).
91. S. Vignolini, E. Moyroud, T. Hingant, H. Banks, P. J. Rudall, U. Steiner, and B. J. Glover, New Phytologist 205, 97 (2015).
92. E. Moyroud, T. Wenzel, R. Middleton, P. J. Rudall, H. Banks, A. Reed, G. Mellers, P. Killoran, M. M. Westwood, U. Steiner, S. Vignolini, and B. J. Glover, Nature 550, 469 (2017).
93. B. D. Wilts, P. J. Rudall, E. Moyroud, T. Gregory, Y. Ogawa, S. Vignolini, U. Steiner, and B. J. Glover, New Phytologist 219, 1124 (2018).
94. K. Vynck, R. Pacanowski, A. Agreda, A. Dufay, X. Granier, and P. Lalanne, Nature Materials 21, 1035 (2022).
95. J. D. Forster, H. Noh, S. F. Liew, V. Saranathan, C. F. Schreck, L. Yang, J. C. Park, R. O. Prum, S. G. Mochrie, C. S. O'Hern, H. Cao, and E. R. Dufresne, Advanced Materials 22, 2939 (2010).
96. L. Schertel, L. Siedentop, J. M. Meijer, P. Keim, C. M. Aegerter, G. J. Aubry, and G. Maret, Advanced Optical Materials 7, 1900442 (2019).
97. H. Cao, Y. G. Zhao, H. C. Ong, S. T. Ho, J. Y. Dai, J. Y. Wu, and R. P. Chang, Applied Physics Letters 73, 3656 (1998).
98. F. Luan, B. Gu, A. S. Gomes, K. T. Yong, S. Wen, and P. N. Prasad, Nano Today 10, 168 (2015).
99. S. W. Chang, W. C. Liao, Y. M. Liao, H. I. Lin, H. Y. Lin, W. J. Lin, S. Y. Lin, P. Perumal, G. Haider, C. T. Tai, K. C. Shen, C. H. Chang, Y. F. Huang, T. Y. Lin, and Y. F. Chen, Scientific Reports 8, 2720 (2018).
100. P. W. Anderson, Physical Review 109, 1492 (1958).
101. M. Rusek, A. Orlowski, and J. Mostowski, Physical Review E 53, 4122 (1996).
102. H. Hu, A. Strybulevych, J. H. Page, S. E. Skipetrov, and B. A. Van Tiggelen, Nature Physics 4, 945 (2008).
103. S. E. Skipetrov and I. M. Sokolov, Physical Review B 98, 1 (2018).
104. Y. Liu, H. Wang, J. Ho, R. C. Ng, R. J. Ng, V. H. Hall-Chen, E. H. Koay, Z. Dong, H. Liu, C. W. Qiu, J. R. Greer, and J. K. Yang, Nature Communications 10, 4340 (2019).
105. J. U. Surjadi, L. Gao, H. Du, X. Li, X. Xiong, N. X. Fang, and Y. Lu, Advanced Engineering Materials 21, 1 (2019).
106. O. Leseur, Diffusion, localisation et absorption de lumiére en milieux désordonnés. Impact des corrélations spatiales du désordre., Phd thesis, Universite\acute{ } Pierre et Marie Curie (2016).
107. J. Sunseri, Z. Slepian, S. Portillo, J. Hou, S. Kahraman, and D. P. Finkbeiner, RAS Techniques and Instruments 2, 62 (2023).
108. C. E. Shannon, Proceedings of the IRE 37, 10 (1949).
109. M. Pharr, W. Jakob, and G. Humphreys, Physically based rendering: From Theory to Implementation, 3rd ed. (Morgan Kaufmann, 2018).
110. A. Pilleboue, G. Singh, D. Coeurjolly, M. Kazhdan, and V. Ostromoukhov, ACM Transactions on Graphics 34, 124 (2015).
111. R. A. Ulichney, Proceedings of the IEEE 76, 56 (1988).
112. O. U. Uche, F. H. Stillinger, and S. Torquato, Physical Review E-Statistical Physics, Plasmas, Fluids, and Related Interdisciplinary Topics 70, 046122 (2004).
113. O. U. Uche, S. Torquato, and F. H. Stillinger, Physical Review E-Statistical, Nonlinear, and Soft Matter Physics 74, 031104 (2006).
114. A. Shih, M. Casiulis, and S. Martiniani, Arxiv Preprint, 2305.15693 (2023).
115. A. H. Barnett, J. Magland, and L. Af Klinteberg, SIAM Journal on Scientific Computing 48, C479 (2019).
116. A. H. Barnett, Applied and Computational Harmonic Analysis 51, 1 (2021).
117. D. P. Mitchell, Proceedings of the 14th Annual Conference on Computer Graphics and Interactive Techniques, SIGGRAPH 1987 21, 65 (1987).
118. D. P. Mitchell, Proceedings of the 18th Annual Conference on Computer Graphics and Interactive Techniques, SIGGRAPH 1991 25, 157 (1991).
119. Y. Eldar, M. Lindenbaum, M. Porat, and Y. Y. Zeevi, in Proceedings of the 12th IAPR International Conference on Pattern Recognition, Vol. 2—Conference B: Computer Vision \& Image Processing (IEEE, Jerusalem, Israel, 1994) pp. 93-97.
120. S. Hiller, O. Deussen, and A. Keller, in Workshop on Visio, Modeling, and Visualization (VMV), November 2001 (Stuttgart, 2001).
121. W.-m. Pang, Y. Qu, T.-t. Wong, D. Cohen-or, and P.-a. Heng, in SIGGRAPH '08, Vol. 89 (2001) pp. 1-8.
122. V. Ostromoukhov, C. Donohue, and P. M. Jodoin, in ACM SIGGRAPH 2004 Papers, SIGGRAPH 2004 (2004) pp. 488-495.
123. H. Li, L. Y. Wei, P. V. Sander, and C. W. Fu, ACM Transactions on Graphics 29, 167 (2010).
124. F. De Goes, K. Breeden, V. Ostromoukhov, and M. Desbrun, ACM Transactions on Graphics 31, 171 (2012).
125. A. C. O\ddot{ } ztireli and M. Grossy, ACM Transactions on Graphics 31, 170 (2012).
126. J. Chen, X. Ge, L. Y. Wei, B. Wang, Y. Wang, H. Wang, Y. Fei, K. L. Qian, J. H. Yong, and W. Wang, ACM Transactions on Graphics 32 (2013).
127. D. Heck, T. Schlomer, and O. Deussen, ACM Transactions on Graphics 32, 25 (2013).
128. M. S. Ebeida, M. A. Awad, X. Ge, A. H. Mahmoud, S. A. Mitchell, P. M. Knupp, and L. Y. Wei, CAD Computer Aided Design 46, 25 (2014).
129. F. Wachtel, A. Pilleboue, D. Coeurjolly, K. Breeden, G. Singh, G. Cathelin, F. De Goes, M. Desbrun, and V. Ostro-moukhov, ACM Transactions on Graphics 33, 56 (2014).
130. D. M. Yan, J. W. Guo, B. Wang, X. P. Zhang, and P. Wonka, Journal of Computer Science and Technology 30, 439 (2015).
131. S. Torquato, Physics Reports 745, 1 (2018).
132. A. Wolfe, N. Morrical, T. Akenine-Moller, and R. Ramamoorthi, “Rendering in Real Time with Spatiotemporal Blue Noise Textures,” (2021).
133. A. Chutinan, N. P. Kherani, and S. Zukotynski, Opt. Express 17, 8871 (2009).
134. H. Inan, M. Poyraz, F. Inci, M. A. Lifson, M. Baday, B. T. Cunningham, and U. Demirci, Chem Soc Rev 46, 366 (2017).
135. W. Liu, H. Ma, and A. Walsh, Renewable and Sustainable Energy Reviews 116, 109436 (2019).
136. K. Vynck, R. Pierrat, R. Carminati, L. S. Froufe- [symbol] rez, F. Sche [symbol] old, R. Sapienza, S. Vignolini, and J. J. [symbol] aenz, Arxiv Preprint, 2106.13892 (2021).
137. F. Bigourdan, R. Pierrat, and R. Carminati, Optics Express 27, 8666 (2019), arXiv: 1806.08188.
138. A. Shih, M. Casiulis, and S. Martiniani, Arxiv Preprint, 2305.15693 (2023).
139. K. Vynck. R. Pacanowski. A. Agreda. A. Dufay. X. Granicr, and P. Lalanne. Nature Materials 21, 1035 (2022).
140. M. M. Milo ̌sevi\acute{ } c, W. Man, G. Nahal, P. J. Steinhardt, S. Torquato, P. M. Chaikin, T. Amoah. B. Yu. R. A. Mullen, and M. Florescu, Scientific Reports 9, 20338 (2019).

1-4. (canceled)

5. A system for optimizing a design of an object, comprising:
at least one computer processor which is configured to:
apply at least one of (i) a fast Fourier transform or (ii) a non-uniform fast Fourier transform to at least one of:
a) generate continuous and discrete point structures with one or more arbitrary statistical correlations, or
b) optimize at least one of at least one position or at least one characteristic of a plurality of elements of the object.

6. The system of claim 5, wherein the optimization occurs in continuous space with or without discretizing Fourier space.

7. The system of claim 5, wherein the design is optimized by optimizing at least one of at least one position or at least one characteristic of a plurality of elements of the object.

8. The system of claim 7, wherein the characteristic of the plurality of elements comprises at least one of a size, a density, or a refractive index.

9. A non-transitory computer accessible medium which includes software thereon for optimizing a design of an object wherein, when at least one computer processor executes the software, the computer processor is configured to perform the procedures, comprising:
applying at least one of (i) a fast Fourier transform or (ii) a non-uniform fast Fourier transform to at least one of:
a) generate continuous and discrete point structures with one or more arbitrary statistical correlations, or
b) optimize at least one of at least one position or at least one characteristic of a plurality of elements of the object.

10. The non-transitory computer accessible medium of claim 9, wherein the optimization occurs in continuous space with or without discretizing Fourier space.

11. The non-transitory computer accessible medium of claim 9, wherein the design is optimized by optimizing at least one of at least one position or at least one characteristic of a plurality of elements.

12. The non-transitory computer accessible medium of claim 11, wherein the characteristic of the plurality of elements comprises at least one of a size, a density, or a refractive index.

13-19. (canceled)

20. A system for optimizing a design of an object, comprising:
at least one computer processor which is configured to:
use a fast Fourier transform to optimize a loss via gradient in a log-linear time scale.

21-23. (canceled)

24. The system of claim 5, wherein the optimization is applied to Monte Carlo Rendering.

25. The system of claim 24, wherein the optimization comprises systematically tailoring a point pattern to a specific integrand.

26. The non-transitory computer accessible medium of claim 9, wherein the optimization is applied to Monte Carlo Rendering.

27. The non-transitory computer accessible medium of claim 26, wherein the optimization comprises systematically tailoring a point pattern to a specific integrand.

28. The system of claim 5, wherein the fast Fourier transform is applied.

29. The system of claim 5, wherein the non-uniform fast Fourier transform is applied.

30. The system of claim 5, wherein the continuous and discrete point structures are generated.

31. The system of claim 5, wherein the at least one position of the object is optimized.

32. The system of claim 5, wherein the at least one characteristic of a plurality of elements of the object is optimized.
